(19) United States
(12) Patent Application Publication
(10) Pub. No.: US 2011/0213976 A1
(43) Pub. Date: Sep. 1, 2011

(54) METHOD FOR DOWNLOADING CONDITIONAL ACCESS SYSTEM FOR DIGITAL BROADCASTING

(75) Inventors: Jeacheol Ryou, Daejeon (KR); Jonghoo Lee, Daejeon (KR); Minyoung Kim, Daejeon (KR)

(73) Assignee: THE INDUSTRY & ACADEMIC COOPERATION IN CHUNGNAM NATIONAL UNIVERSITY (IAC), DAEJEON (KR)

(21) Appl. No.: 13/106,505

(22) Filed: May 12, 2011

Related U.S. Application Data
(63) Continuation of application No. PCT/KR2009/005230, filed on Sep. 15, 2009.

(30) Foreign Application Priority Data
Nov. 25, 2008 (KR) 10-2008-0117399

(51) Int. Cl. H04L 9/32

(52) U.S. Cl. 713/169

(57) ABSTRACT

The present invention relates to a method of downloading a conditional access system (CAS) for digital broadcasting in a digital broadcasting system. More specifically, the present invention includes a transmitter which includes a DCAS authentication proxy (AP), a personalization server, a DCAS provisioning server, and a head-end, and a set-top box as a receiver, which includes a DCAS host. In particular, a mutual authentication occurs between the DCAS AP and the DCAS host and key distribution, between the personalization server and the DCAS host and key distribution, and between the DCAS provisioning server and the DCAS host and key distribution in order to protecting a conditional access system that descrambles scrambled broadcasting contents when broadcasting contents are downloaded from an IP-TV broadcasting system and viewed.

### CROSS-REFERENCES TO RELATED APPLICATION

This is a continuation of International Application No., PCT/KR2009/005230, with an international filing date of Sep. 15, 2009, which claims the benefit of Korean Application No. 10-2008-117399 filed Nov. 25, 2008, the entire contents of which are incorporated herein by reference.

### BACKGROUND

1. Technical Field

The present invention relates to a method of safely downloading a conditional access system applied to digital broadcasting and a method of transmitting and receiving digital broadcasting contents.

2. Related Art

A conditional access system (CAS) introduces a subscriber concept to broadcasting systems to allow only viewers eligible to receive digital broadcasting contents to view the digital broadcasting contents in order to protect certain viewers from viewing certain digital broadcasting contents. The CAS is composed of an apparatus on a transmitting side (broadcasting station) for encrypting broadcasting contents and authenticating subscribers (receivers) and apparatuses at a subscriber side (receiver) for storing subscriber information and decrypting the broadcasting contents. Furthermore, these apparatuses have scrambling/descrambling functions, entitlement management and control functions, etc.

Scrambling/Descrambling

Generally, when a scrambling function is operated, broadcasting data is scrambled such that recipients who are not eligible to receive the broadcasting data cannot view the broadcasting data. Broadcasting contents are scrambled and descrambled using a control word (CW). The control word is encrypted and transmitted with the scrambled broadcasting data. Accordingly, a recipient decrypts the encrypted control word and descrambles the broadcasting data using the decrypted control word.

Entitlement Control

Typically, control words are encrypted using an authentication key (AK), embedded in an entitlement control message (ECM) and transmitted to a recipient. More specifically, the ECM has a structure such as ‘E_{AK}[CW, control variable]’. Furthermore, a newly generated and encrypted control word may be periodically transmitted. Additionally, the ECM may include a control variable in addition to the encrypted control word. As such, a receiver decrypts the control word and descrambles received broadcasting data by using the control word.

Entitlement Management

In standard embodiments, entitlement management gives entitlement to a receiver, updates and manages the entitlement, encrypts the authentication key by using a distribution key (DK) to generate an entitlement management message (EMM) and transmits the EMM to a recipient. Typically, the EMM has a structure such as ‘E_{DK}[AK, entitlement information]’. Accordingly, a sender and a recipient must share the same secret key, that is, distribution key, and hardware such as a smart card (generally used to improve security during a process of sharing the secret key).

Current Korean cable broadcasting conforms to an Open Cable System of American standard. The Open Cable system is a hardware system which stores subscriber information in a separate cable card (a conditional access module) and attaches/detaches the cable card to/from a set-top box (subscriber terminal). Another hardware system is an embedded CAS constructed in such a manner that a CAS module is embedded in a set-top box. However, these hardware conditional access clients have shortcomings in that they have low compatibility, low interoperability and insufficient security.

Compatibility

It is difficult to secure compatibility between hardware conditional access systems produced by different manufacturers. Thus, the current systems often are not compatible between alternate manufactures.

Interoperability with Other Services

Hardware conditional access systems are difficult to interoperate with other services such as digital right management (DRM) while there is a rising interest on the DRM as the importance of intellectual property rights are emphasized.

Security

It is not easy to cope with the situation in which an encryption algorithm embedded in the hardware conditional access system is cracked or key information is exposed although the hardware conditional access system has high security in protecting the key information. That is, there is no method for handling safety accidents other than changing hardware.

To solve the problems of the hardware conditional access systems, ‘software CAS’ and ‘downloadable CAS (DCAS)’ which process subscriber information in a software manner rather than in a hardware manner in a set-top box have been developed to implement software conditional access clients. The DCAS is a CAS that is downloaded from a server to a secure micro chip when a set-top box is linked to a network, which is distinguished from a CAS provided by a service provider and previously installed in a set-top box. Here, other secure modules such as DRM and authorized service domain (ASD) can be downloaded with the CAS.

The conventional DCAS operates as follows.

(1) A DCAS authentication proxy (AP) and a DCAS host have a pre-shared key.

(2) The DCAS AP broadcasts a message for discovering the DCAS host first when required to download a CAS client program.

(3) The DCAS AP can identify a set-top box when the DCAS host responds to the message.

(4) The DCAS AP transmits an encryption key that will be used to encrypt the CAS client program to be downloaded to the DCAS host. Here, the pre-shared key is used to encrypt the encryption key.

(5) The DCAS AP encrypts the CAS client program by using the encryption key and downloads the encrypted CAS client program to the DCAS host. Then, the CAS client normally operates in the DCAS host.

(6) A broadcasting system transmits a key (control word) used to scramble broadcasting contents to the DCAS host.

(7) The broadcasting system transmits scrambled broadcasting contents to the DCAS host.

In this conventional method, mutual authentication between the DCAS AP and the DCAS host is not performed when the DCAS AP discovers the DCAS host and the shared key distributing process for protecting the encryption key used to encrypt the CAS is not clear.

Although the software CAS have several advantages over the hardware CAS, the software CAS also has its own problems. For example, damages from malicious software are spreading on the Internet. This problem can be generated in digital broadcasting as well. That is, a hacker who disguises himself as a conditional access server can download a malicious code that causes problems in systems or networks to a conditional access client to damage a user or a broadcasting system operator such as causing service error, economic loss, etc. Particularly, the conditional access system performs the core function of descrambling broadcasting contents, and thus the entire broadcasting services may be damaged if a CAS system program is forged/falsified while being downloaded.

Accordingly, the present invention has been made in view of the problems occurring in the prior art, and a primary object of the present invention is to solve security problems that may be generated in the conventional method and improve the security of the entire system.

Another object of the present invention is to provide a method of protecting a conditional access system that descrambles scrambled broadcasting contents when broadcasting contents are downloaded from an IP-TV broadcasting system and viewed.

### SUMMARY OF THE DISCLOSURE

In one aspect, there is provided a method of downloading a conditional access system (CAS) for digital broadcasting in a digital broadcasting system comprising a broadcasting system as a transmitter, which includes a DCAS authentication proxy (AP), a personalization server, a DCAS provisioning server, and a head-end, and a set-top box as a receiver, which includes a DCAS host. In particular this method starts by commencing (A) a mutual authentication between the DCAS AP and the DCAS host and key distribution. Mutual authentication between the DCAS AP and the DCAS host and key distribution occurs by generating a shared key from a license number inputted to the set-top box, a step in which the DCAS AP and the DCAS host mutually authenticate each other using the shared key, and a step in which the DCAS AP generates a temporary key (TK) and distributes the TK to the DCAS host and the personalization server upon completion of the mutual authentication. Then, (B) a mutual authentication is conducted between the personalization server and the DCAS host and key distribution. In this step, the personalization server and the DCAS host mutually authenticate each other using the TK and a step in which the personalization server generates a session key (SK) and distributes the SK to the DCAS host and the DCAS provisioning server upon completion of the mutual authentication. Finally, (C) a mutual authentication between the DCAS provisioning server and the DCAS host and key distribution is conducted. Here, the DCAS provisioning server encrypts CAS software by using the SK and transmits the encrypted CAS software to the DCAS host and a step in which the DCAS host decrypts the encrypted CAS software by using the SK and installs the CAS software.

In an aspect of the present invention, the (A) mutual authentication between the DCAS AP and the DCAS host may also obtain a hash value of the inputted license number, divides the hash value into two values and respectively stores the two values as a shared key for transmission and a shared key for receiving. Additionally, the DCAS AP previously storing the shared key for transmission and the shared key for receiving with respect to the license number generates a first arbitrary value a1 and transmits the first arbitrary value a1 to the DCAS host. Then the DCAS host encrypts the first arbitrary value a1 received from the DCAS AP by using the shared key for transmission and transmits the encrypted first arbitrary value with a second arbitrary value a2 to the DCAS AP. The DCAS AP then decrypts the encrypted first arbitrary value a1 by using the shared key for receiving to confirm the first arbitrary value a1, encrypts the second arbitrary value a2 transmitted from the DCAS host and the TK by using the shared key for transmission, and transmits the encrypted second arbitrary value a2 and TK to the DCAS host. The DCAS host decrypts the second arbitrary value a2 by using the shared key for receiving and then extracts the TK by using the shared key for receiving. The TK is then transmitted by the DCAS AP to the personalization server.

In an aspect of the present invention, the (B) mutual authentication between the personalization server and the DCAS may also include a step in which the personalization server may encrypt a predetermined message and the SK by using the TK and transmit the encrypted message and SK with a third arbitrary value a3 to the DCAS host. The DCAS host then decrypts the encrypted message and SK by using the TK to confirm the predetermined message and extracts the SK. Next, the DCAS host encrypts the third arbitrary value a3 by using the SK and transmits the encrypted third arbitrary value to the personalization server The personalization server in turn decrypts the encrypted third arbitrary value by using the SK to confirm the third arbitrary value a3 and then transmits the same SK to the DCAS provisioning server.

In an aspect of the present invention, the (C) mutual authentication between the DCAS provisioning server and the DCAS host may also include a step in which the DCAS provisioning server encrypts the CAS software and a hash value of the CAS software by using the SK and transmits the encrypted CAS software and hash value to the DCAS host. The DCAS host, in this case, then decrypts the information received from the DCAS provisioning server by using the SK to acquire the CAS software and compares the CAS software with the hash value transmitted together with the CAS software to confirm that the CAS software has not been varied while being downloaded. In response, the DCAS host installs the decrypted CAS software.

Furthermore, in some embodiments of the present invention, (A) the DCAS AP and the personalization server may respectively transmit the TK and the SK to a head-end for digital broadcasting. Then, (B) the head-end encrypts an authentication key by using H (temporary key ∥ session key) as a distribution key, distributes the authentication key, encrypts a control word by using the authentication key, distributes the control word, scrambles broadcasting contents by using the control word and transmits the scrambled broadcasting content to a set-top box. Next (C) a conditional access system installed in the DCAS host decrypts the authentication by using H (temporary key ∥ session key) as the distribution key, decrypts the control word by using the decrypted authentication key and descrambles the broadcasting contents by using the control word.

IP-TV systems to which a conventional DCAS is applied have weak points in the authentication between a broadcasting system and an IP-TV set-top box and management of an encryption key used to encrypt downloaded CAS software. Accordingly, hackers can disguise themselves as broadcasting systems to download malicious codes to subscribers or unauthenticated users can download the CAS software and illegally watch broadcasting contents.

According to the present invention, the DCAS AP and DCAS host perform mutual authentication based on challenge-response system, and thus it is possible to block an attack that induces connection of the DCAS host to a site set up by an attacker who disguises himself as a DCAS AP.

According to the present invention, the personalization server and DCAS host perform mutual authentication based on challenge-response system, and thus it is possible to block an attack of a hacker who disguises himself as a personalization server to induce the DCAS host to download a malicious code.

According to the present invention, CAS software downloaded from the DCAS provisioning server to the DCAS host can be encrypted so as to prevent an unauthenticated user who does not know an encryption key used for the encryption from downloading the CAS software and illegally viewing broadcasting contents.

According to the present invention, a key used to scramble broadcasting contents is distributed with CAS software when the CAS software is downloaded, and thus an unauthenticated user can be prevented from illegally watching the broadcasting contents.

According to the present invention, broadcasting service providers can provide software CAS to subscribers so as to reduce maintenance costs and block unauthenticated users from illegally watching broadcasting contents to maximize profits.

According to the present invention, IP-TV subscribers do not suffer from the same inconveniences of the conventional systems when using the newest CAS through software CAS and can be provided with IP-TV service safely from external attacks such as introduction of malicious codes.

### BRIEF DESCRIPTION OF THE DRAWINGS

Further objects and advantages of the invention can be more fully understood from the following detailed description taken in conjunction with the accompanying drawings, in which:

FIG. 1 illustrates a configuration of a broadcasting system for protecting CAS to which the present invention is applied; and

FIGS. 2, 3 and 4 illustrate an exemplary mutual authentication process in a digital broadcasting CAS downloading method according to an illustrative embodiment of the present invention.

### DETAILED DESCRIPTION OF EMBODIMENTS

The present invention will now be described more fully with reference to the accompanying drawings, in which exemplary embodiments of the invention are shown. The invention may, however, be embodied in many different forms and should not be construed as being limited to the embodiments set forth herein. It will be understood by those of ordinary skill in the art that various changes in form and details may be made therein without departing from the spirit and scope of the present invention.

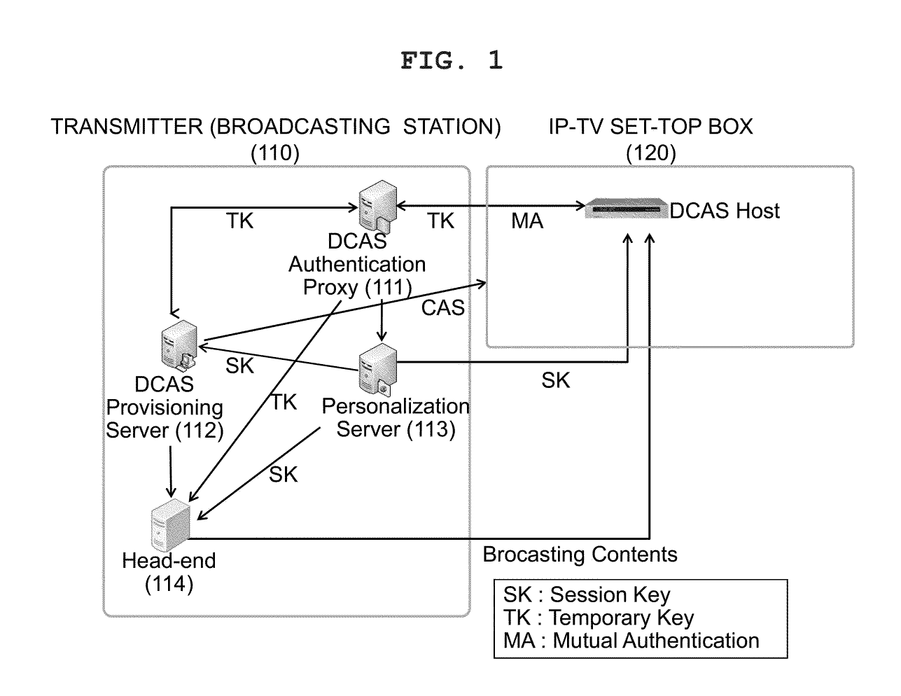

FIG. 1 illustrates a configuration of a safely downloadable conditional access system (DCAS). Referring to FIG. 1, a broadcasting system 110 includes a DCAS AP 111, a DCAS provisioning server 112, a personalization server 113, and a head-end 114. Although a head-end system has a complicated structure due to many lower level components, the head-end 114 is simplified in the description of the present invention.

A broadcasting service provider discovers an IP-TV set-top box 120 of a subscriber through the DCAS AP 111 and confirms whether the subscriber is a rightful subscriber through mutual authentication between the broadcasting service provider and a DCAS host installed in the set-top box. In the mutual authentication process, a key used to authenticate the personalization server when the DCAS host is connected to the personalization server to download a CAS is exchanged. The personalization server distributes an encryption key that will be used to encrypt a CAS client while performing mutual authentication with the DCAS host. The DCAS provisioning server 112 encrypts CAS software by using the encryption key distributed during the mutual authentication between the personalization server and the DCAS host and transmits the encrypted CAS software to the DCAS host.

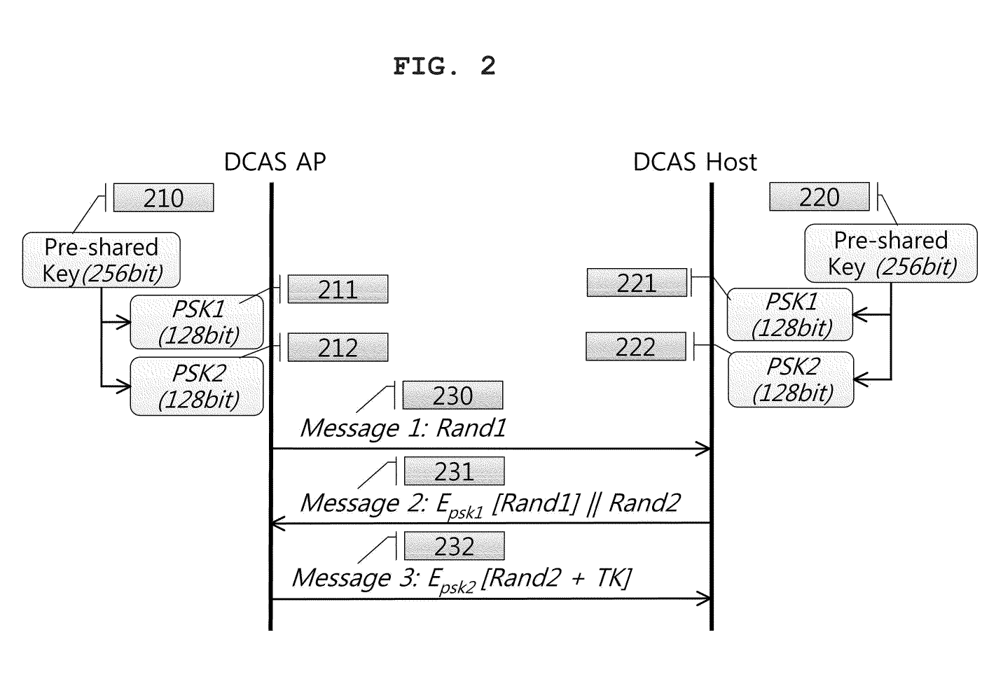

FIG. 2 illustrates an exemplary mutual authentication between the DCAS AP 111 and the DCAS host 120. Reference numerals 210 and 220 represent illustrative key information distributed when the IP-TV set-top box is initially installed. The illustrative key information is identical to a hash value of a license key distributed in a printed form together with software distributed when the IP-TV set-top box is installed. Accordingly, the values 210 and 220 are identical to each other. When the mutual authentication shown in FIG. 2 is started, the key information 210 is divided into values 211 and 212 and the key information 220 is divided into values 221 and 222. This is for the purpose of improving security by changing a used key based on a transmission direction.

The DCAS AP then transmits a challenge value, e.g., Rand1, to the DCAS host in step 230. The DCAS host in response generates a response value such as Epsk1[Rand1] and transmits the response value and a challenge value, such as Rand2, for DCAS AP authentication in step 231.

The DCAS AP next calculates, in this example, Epsk1[Rand1] and confirms whether the calculated value corresponds to the value transmitted from the DCAS host to authenticate the DCAS host in step 232. In addition, the DCAS AP generates a response value, e.g., Epsk2[Rand2+TK], for the challenge value transmitted from the DCAS host and transmits the response value to the DCAS host. Here, TK represents a temporary key which will be transmitted to the DCAS personalization server (PS).

After the step 232, the DCAS host decrypts, in this case, Epsk2[Rand2+TK], considers the DCAS AP to be rightful if the decryption result includes the challenge value Rand2 transmitted from the DCAS host, finishes the authentication and stores the TK. The DCAS AP then transmits the TK, generated by the DCAS AP, to the personalization server.

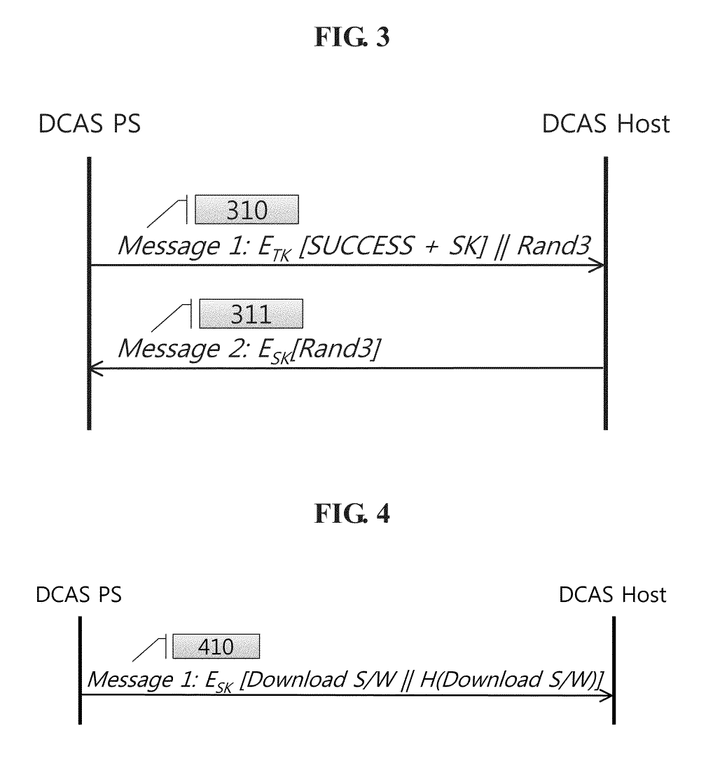

FIG. 3 illustrates an exemplary mutual authentication between the personalization server 113 and the DCAS host 120 included in the broadcasting system 110. The personalization server 113 encrypts a key SK which will be used to encrypt the CAS software and an appointed message SUCCESS by using the TK received from the DCAS AP and transmits the encrypted key and message to the DCAS host in step S310. Here, a challenge value, e.g., Rand3, for authenticating the DCAS host is transmitted with the encrypted key and message.

The DCAS host then decrypts the message transmitted from the personalization server and considers the personalization server as a rightful personalization server having the TK if the decrypted message includes the appointed message SUCCESS in step 311. Then, the DCAS host generates a response by using the acquired challenge value, in this case, Rand3 and SK and transmits the response to the personalization server.

Upon step 311 completing, the personalization server confirms the message transmitted from the DCAS host to finish authentication and transmits the SK to the DCAS provisioning server.

FIG. 4 illustrates an exemplary process of safely downloading the CAS software from the DCAS provisioning server to the DCAS host after the completion of the mutual authentication between the DCAS AP and the DCAS host and the mutual authentication between the personalization server and the DCAS host.

The DCAS provisioning server encrypts the DCAS client program such as E_{SK}[CAS software] by using the SK received from the personalization server during the mutual authentication between the personalization server and the DCAS host and transmits the encrypted DCAS client program to the DCAS host in step 410. Here, the DCAS provisioning server transmits a hash value of the CAS software together with the encrypted DCAS client program so that the DCAS host can confirm whether the CAS software has been varied while being downloaded.

After the process shown in FIG. 4, a process of scrambling broadcasting contents in the head-end of the broadcasting system and transmitting the scrambled broadcasting contents to the DCAS host is performed. Here, the value (DK=H(TK ∥ SK)), obtained by adding up the previously distributed temporary key TK and session key SK and performing a hash operation on the addition result, is used as a distribution key. That is, a key value used to scramble the broadcasting contents is distributed during the CAS software downloading process.

The present invention can block an attacker from inducing the DCAS host to be connected to a site set up by the attacker who disguises himself as a broadcasting system or induce the DCAS host to download a malicious code to thereby improve security vulnerability of the entire system.

Furthermore, the present invention can provide software CAS to subscribers so as to reduce maintenance cost and prevent unauthenticated users from illegally viewing broadcasting contents to thereby maximize profits of broadcasting service providers.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of downloading a conditional access system (CAS) for digital broadcasting in a digital broadcasting system comprising a broadcasting system as a transmitter, which includes a DCAS authentication proxy (AP), a personalization server, a DCAS provisioning server, and a head-end, and a set-top box as a receiver, which includes a DCAS host, the method comprising:
(A) mutual authentication between the DCAS AP and the DCAS host and key distribution comprising a step of generating a shared key from a license number inputted to the set-top box, a step in which the DCAS AP and the DCAS host mutually authenticate each other using the shared key, and a step in which the DCAS AP generates a temporary key (TK) and distributes the TK to the DCAS host and the personalization server upon completion of the mutual authentication;
(B) mutual authentication between the personalization server and the DCAS host and key distribution comprising a step in which the personalization server and the DCAS host mutually authenticate each other using the TK and a step in which the personalization server generates a session key (SK) and distributes the SK to the DCAS host and the DCAS provisioning server upon completion of the mutual authentication; and
(C) mutual authentication between the DCAS provisioning server and the DCAS host and key distribution comprising a step in which the DCAS provisioning server encrypts CAS software by using the SK and transmits the encrypted CAS software to the DCAS host and a step in which the DCAS host decrypts the encrypted CAS software by using the SK and installs the CAS software.

2. The method according to claim 1, wherein the (A) mutual authentication between the DCAS AP and the DCAS host comprises:
a step of obtaining the hash value of the inputted license number, dividing the hash value into two values and respectively storing the two values as a shared key for transmission and a shared key for receiving;
a step in which the DCAS AP previously storing the shared key for transmission and the shared key for receiving with respect to the license number generates a first arbitrary value a1 and transmits the first arbitrary value a1 to the DCAS host;
a step in which the DCAS host encrypts the first arbitrary value a1 received from the DCAS AP by using the shared key for transmission and transmits the encrypted first arbitrary value with a second arbitrary value a2 to the DCAS AP;
a step in which the DCAS AP decrypts the encrypted first arbitrary value a1 by using the shared key for receiving to confirm the first arbitrary value a1, encrypts the second arbitrary value a2 transmitted from the DCAS host and the TK by using the shared key for transmission and transmits the encrypted second arbitrary value a2 and TK to the DCAS host;
a step in which the DCAS host decrypts the second arbitrary value a2 by using the shared key for receiving and then extracts the TK by using the shared key for receiving; and
a step in which the DCAS AP transmits the TK to the personalization server.

3. The method according to claim 1, wherein the (B) mutual authentication between the personalization server and the DCAS host comprises:
a step in which the personalization server encrypts a predetermined message and the SK by using the TK and transmits the encrypted message and SK with a third arbitrary value a3 to the DCAS host;
a step in which the DCAS host decrypts the encrypted message and SK by using the TK to confirm the predetermined message and extract the SK;
a step in which the DCAS host encrypts the third arbitrary value a3 by using the SK and transmits the encrypted third arbitrary value to the personalization server; and
a step in which the personalization server decrypts the encrypted third arbitrary value by using the SK to confirm the third arbitrary value a3 and then transmits the same SK to the DCAS provisioning server.

4. The method according to claim 2, wherein the (B) mutual authentication between the personalization server and the DCAS host comprises:
a step in which the personalization server encrypts a predetermined message and the SK by using the TK and transmits the encrypted message and SK with a third arbitrary value a3 to the DCAS host;
a step in which the DCAS host decrypts the encrypted message and SK by using the TK to confirm the predetermined message and extract the SK;
a step in which the DCAS host encrypts the third arbitrary value a3 by using the SK and transmits the encrypted third arbitrary value to the personalization server; and
a step in which the personalization server decrypts the encrypted third arbitrary value by using the SK to confirm the third arbitrary value a3 and then transmits the same SK to the DCAS provisioning server.

5. The method according to claim 2, wherein the (B) mutual authentication between the personalization server and the DCAS host comprises:
a step in which the personalization server encrypts a predetermined message and the SK by using the TK and transmits the encrypted message and SK with a third arbitrary value a3 to the DCAS host;
a step in which the DCAS host decrypts the encrypted message and SK by using the TK to confirm the predetermined message and extract the SK;
a step in which the DCAS host encrypts the third arbitrary value a3 by using the SK and transmits the encrypted third arbitrary value to the personalization server; and
a step in which the personalization server decrypts the encrypted third arbitrary value by using the SK to confirm the third arbitrary value a3 and then transmits the same SK to the DCAS provisioning server.

6. The method according to claim 1, wherein the (C) mutual authentication between the DCAS provisioning server and the DCAS host comprises:
a step in which the DCAS provisioning server encrypts the CAS software and the hash value of the CAS software by using the SK and transmits the encrypted CAS software and hash value to the DCAS host;
a step in which the DCAS host decrypts the information received from the DCAS provisioning server by using the SK to acquire the CAS software and compares the CAS software with the hash value transmitted together with the CAS software to confirm that the CAS software has not been varied while being downloaded; and
a step in which DCAS host installs the decrypted CAS software.

7. The method according to claim 2, wherein the (C) mutual authentication between the DCAS provisioning server and the DCAS host comprises:
a step in which the DCAS provisioning server encrypts the CAS software and the hash value of the CAS software by using the SK and transmits the encrypted CAS software and hash value to the DCAS host;
a step in which the DCAS host decrypts the information received from the DCAS provisioning server by using the SK to acquire the CAS software and compares the CAS software with the hash value transmitted together with the CAS software to confirm that the CAS software has not been varied while being downloaded; and
a step in which DCAS host installs the decrypted CAS software.

8. A method of transmitting/receiving digital broadcasting in a digital broadcasting system according to the method according to claim 1, the method comprising:
(A) step in which the DCAS AP and the personalization server respectively transmit the TK and the SK to a head-end for digital broadcasting;
(B) step in which the head-end encrypts an authentication key by using H (temporary key ∥ session key) as a distribution key, distributes the authentication key, encrypts a control word by using the authentication key, distributes the control word, scrambles broadcasting contents by using the control word and transmits the scrambled broadcasting content to a set-top box; and
(C) step in which a conditional access system installed in the DCAS host decrypts the authentication by using H (temporary key ∥ session key) as the distribution key, decrypts the control word by using the decrypted authentication key and descrambles the broadcasting contents by using the control word.

9. A method of transmitting/receiving digital broadcasting in a digital broadcasting system according to the method according to claim 2, the method comprising:
(A) step in which the DCAS AP and the personalization server respectively transmit the TK and the SK to a head-end for digital broadcasting;
(B) step in which the head-end encrypts an authentication key by using H (temporary key ∥ session key) as a distribution key, distributes the authentication key, encrypts a control word by using the authentication key, distributes the control word, scrambles broadcasting contents by using the control word and transmits the scrambled broadcasting content to a set-top box; and
(C) step in which a conditional access system installed in the DCAS host decrypts the authentication by using H (temporary key ∥ session key) as the distribution key, decrypts the control word by using the decrypted authentication key and descrambles the broadcasting contents by using the control word.

10. A system for downloading a conditional access system (CAS) for digital broadcasting in a digital broadcasting system comprising
a transmitter, which includes a first server, a second server, a third server, and a head-end, and
a receiver, which includes a DCAS host,
wherein a mutual authentication is performed between the DCAS AP and the DCAS host and key distribution wherein a shared key is generated from a license number inputted to the set-top box, the DCAS AP and the DCAS host mutually authenticate each other using the shared key, and the DCAS AP generates a temporary key (TK) and distributes the TK to the DCAS host and the personalization server upon completion of the mutual authentication;
wherein mutual authentication is performed between the personalization server and the DCAS host and key distribution, the personalization server and the DCAS host mutually configured to mutually authenticate each other using the TK and the personalization server configured to generate a session key (SK) and distribute the SK to the DCAS host and the DCAS provisioning server upon completion of the mutual authentication, and
wherein mutual authentication is performed between the DCAS provisioning server and the DCAS host and key distribution, the DCAS provisioning server configured to encrypt CAS software by using the SK and transmits the encrypted CAS software to the DCAS host, the DCAS host configured to decrypt the encrypted CAS software by using the SK and install the CAS software.
